(19) United States
(12) Patent Application Publication
(10) Pub. No.: US 2022/0222688 A1
(43) Pub. Date: Jul. 14, 2022

(54) METHODOLOGY OF ANALYZING CONSUMER INTENT FROM USER INTERACTION WITH DIGITAL ENVIRONMENTS

(71) Applicant: CARS.COM, LLC, Chicago, IL (US)

(72) Inventors: Chenwei Wang, Chicago, IL (US); Addhyan Pandey, Chicago, IL (US); Sanjay Dasari, Chicago, IL (US); Joao Moreira, Chicago, IL (US); Sean Shookman, Chicago, IL (US); Srilakshmi Rayapeddi, Schaumburg, IL (US); Salin Thomas, Prospect Heights, IL (US); Chirag S. Patel, Naperville, IL (US)

(21) Appl. No.: 17/147,948

(22) Filed: Jan. 13, 2021

(51) Int. Cl. G06Q 30/02; G06Q 50/00; G06Q 10/10; G06N 20/00; G06N 5/04; G06F 40/205; G10L 15/26

(52) U.S. Cl. CPC G06Q 30/0202; G06Q 50/01; G06Q 10/10; G10L 15/26; G06N 20/00; G06N 5/04; G06F 40/205; G06Q 30/0201

(57) ABSTRACT

Systems and methods for predicting user actions based upon electronic communication between a user and an organization are disclosed. Based upon user interactions with an organization via electronic communication channels (e.g., e-mail, electronic chat, or voice/video calls), a trained predictive model is used to predict a probability of a future user action relating to the organization. Such user electronic communication is processed to generate message features from message content and metadata, which message features are then combined with other user data features associated with the user or with user interaction with an electronic data system of the organization. The combined data set of message features and user data features is analyzed by the predictive model to generate an output value indicative of a predication of a future user action.

### TECHNICAL FIELD

The present disclosure generally relates to systems and methods for improving analytics relating to predicting user actions based upon monitoring and evaluating user online interactions.

### BACKGROUND

Data regarding user interactions with online resource providers are often recorded for various analysis and process-improvement purposes. Such data may include form data submitted by users, metadata regarding user paths through a website or application, or communication data such as user chat or e-mail messages to a resource provider. However, existing techniques of data collection and analysis do not provide adequate information for all uses. Existing techniques do not distinguish between user interactions indicative of different types of user intent, and thus do not enable accurate prediction of future user actions based upon the collected data. This problem is of particular significance for infrequent user actions, where data regarding past actions of a specific user may be unavailable. For example, prediction of whether a user of an electronic vehicle marketplace will make a purchase of a specific vehicle (or any vehicle) within a relevant time period after requesting information regarding available vehicles from a vehicle dealer presents a particular challenge because of the relatively sparse data for both the user and the vehicle dealer.

### SUMMARY

The present application discloses a method, system, and computer-readable medium storing instructions for improving prediction of user actions based upon communication interactions by the user. The method, system, or instructions may include receiving a consumer interaction record containing a message content of a message from a consumer to a vehicle dealer and an indication of the consumer; parsing the message content into a plurality of message features corresponding to input categories of a predictive model; obtaining user data associated with the consumer based upon the indication of the consumer; extracting user data features corresponding to further input categories of the predictive model from the user data; merging the user data features and the message features to generate an input data set indicating interaction between the consumer and the vehicle dealer; generating an output value by applying the predictive model to the input data set, the output value indicating a probability of the consumer taking a specified action associated with the vehicle dealer within a predefined time interval; and/or presenting a report including an indication of the probability of the consumer taking the specified action associated with the vehicle dealer within the predefined time interval.

Some embodiments may include receiving a second consumer interaction record containing a second message content from the consumer to the vehicle dealer and a second indication of the consumer; parsing the second message content into a plurality of second message features corresponding to input categories of the predictive model; merging, by the one or more processors, the user data features and the second message features to generate a second input data set indicating interaction between the consumer and the vehicle dealer; generating a second output value by applying the predictive model to the input data set, the second output value indicating a second probability of the consumer taking the specified action associated with the vehicle dealer within the predefined time interval; and/or calculating a combined probability of the consumer taking the specified action associated with the vehicle dealer within the predefined time interval based upon the probability and the second probability. In such embodiments, the indication of the probability included in the report may be based upon the combined probability of the consumer taking the specified action associated with the vehicle dealer within the predefined time interval.

Further embodiments in which the specified action comprises purchasing a vehicle from the vehicle dealer may include obtaining a user interaction data set comprising a plurality of interaction data entries, each interaction data entry including a plurality of message features and user data features associated with a user interaction of a training data user with a training data vehicle dealer; obtaining a purchase data set comprising a plurality of purchase data entries associated with vehicle purchases, each purchase data entry including a plurality of purchase features; merging the purchase data entries with the interaction data entries based upon training data user identifiers to generate a training data set comprising a plurality of training data entries, each training data entry including (i) the plurality of message features from the corresponding interaction data entry, (ii) one or more user data features from the corresponding interaction data entry, and/or (iii) either one or more purchase features from the corresponding purchase data entry or an indication of no corresponding purchase data entry being found in the purchase data set; selecting one or more untrained data models for predicting a probability of an outcome based upon input variables; training the one or more untrained data models using the training data set to obtain corresponding one or more trained data models; determining that one of the one or more trained data models meets selection criteria; and/or selecting the trained data model as the predicting model.

The user data may comprise site interaction data regarding interaction of the consumer with one or more portions of a web site or a mobile application associated with the vehicle dealer. Additionally or alternatively, the user data may comprise demographic data regarding the consumer, which may include one or more of the following: a location associated with the user, an income associated with the user, an age of the user, price preferences associated with the consumer, or prior vehicle purchases or leases by the consumer.

In some embodiments, parsing the message content may comprise applying a natural language processing model to the message content to generate the message features. In various embodiments, the message content comprises one or more of the following: communication content within an e-mail message sent by the consumer to an e-mail address associated with the vehicle dealer, communication content within an electronic chat message from the consumer to a recipient associated with the vehicle dealer, or communication content within an audio message from the consumer to a representative of the vehicle dealer. In some embodiments in which the message content includes an audio message as part of a voice call between the consumer and the representative of the vehicle dealer, a transcript of at least a portion of the voice call may be generated to comprise the communication content within the audio message.

In various embodiments, additional, fewer, or alternate actions may be included or performed by the method, system, and computer-readable medium, including those discussed elsewhere herein.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates a block diagram of an exemplary data system on which the methods described herein may operate in accordance with the embodiments described herein.

FIG. 2 illustrates a block diagram of an exemplary computing device in accordance with the embodiments described herein.

FIG. 3 illustrates a flow diagram of an exemplary predictive analytics method for predicting, analyzing, and reporting likelihood of actions by users based upon user interaction data.

FIG. 4 illustrates a flow diagram of an exemplary model training method for generating a predictive model of user actions.

FIG. 5 illustrates a flow diagram of an exemplary user action prediction method for predicting a probability of a user action using message data for user communications.

FIG. 6 illustrates a flow diagram of an exemplary vehicle purchase prediction method for predicting a probability of a consumer purchasing a vehicle based upon interaction with a vehicle dealer.

### DETAILED DESCRIPTION

The invention described herein is related to methods and systems that predict further actions of user based upon observed electronic communication between a user and an organization. Such predictions may be further based upon additional user data, such as data in a user profile or observed user interaction with an electronic data system (e.g., a website or application of the organization). User interaction data indicative of the communication is processed to obtain message features, while user data or additional user interaction data indicative of user interaction with the electronic data system is processed to obtain user data features. The message features and the user data features are combined into an input data set, which is analyzed by a trained predictive model to generate one or more output values indicative of expected user actions (e.g., probabilities or expected values of user actions). Such predictions may then be presented in a report to the organization, which may include additional information for useful comparison.

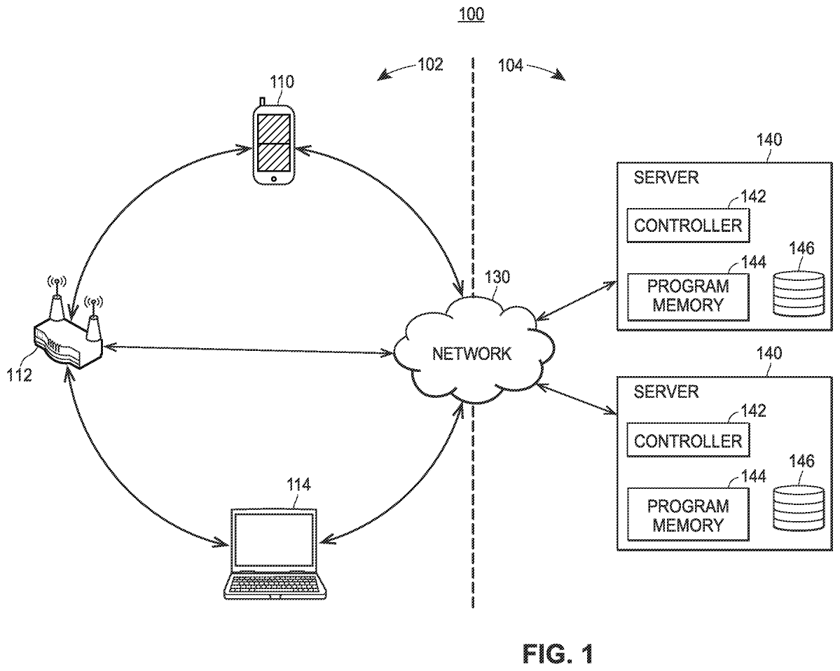

FIG. 1 illustrates a block diagram of an exemplary data system 100. The high-level architecture includes both hardware and software applications, as well as various data communications channels for communicating data between the various hardware and software components. The data system 100 may be roughly divided into front-end components 102 and back-end components 104. The front-end components 102 may communicate via a network 130 with the back-end components 104, as well as with other front-end components 102. For example, the front-end components 102 may include a plurality of computing systems communicatively connected to the back-end components 104 via the network 130. As illustrated, the computing systems may include one or more client computing devices 110 associated with a user (e.g., a smartphone or personal computer of a customer) and one or more analyst computing device 114 associated with a reviewer or analyst of the data (e.g., a desktop computer, notebook, or tablet computer). The client computing device 110 may be used by a user to request and obtain data using one or more software programs, which data may include information regarding vehicles or vehicle dealers. The analyst computing device 114 may be used by an operator to request and review data regarding user interactions with the one or more client computing devices 110, which may be obtained by the analyst computing device 114 from one or more servers 140 via the network 130. In some embodiments, the analyst computing device 114 may instead be a back-end component 104, directly or indirectly connected to one or more servers 140. In further embodiments, the client computing devices 110 or the analyst computing devices 114 may communicate with one or more routers 112 to exchange data with each other or with the back-end components 104. Although one client computing device 110 and one analyst computing device 114 are shown, it should be understood that the data system 100 may include a plurality of each or either (e.g., hundreds or thousands of such devices). Any of the front-end components 102 may be directly or indirectly (e.g., through a router 112) connected to the network 130.

The back-end components 104 may operate in coordination with the front-end components 102 to collect, analyze, and present information. To this end, the back-end components 104 may include a server 140 that stores information received from the front-end components 102 via the network 130. The server 140 may further provide requested data to the front-end components 102, such as vehicle data or report data. In some embodiments, the back-end components 104 may include a plurality of servers 140 performing distinct or overlapping functions. For example, a first server 140 may provide data in response to user requests and store information associated with such user requests for further analysis, while a second server 140 may perform analysis on user data captured by the first server 140. Alternatively, one server 140 may perform any or all of the functions described herein. The server 140 may include a controller 142 to process data and run software programs, applications, or routines stored in a program memory 144 as executable instructions, and the server 140 may further include or be communicatively connected to a database 146 for data storage and retrieval.

The front-end components 102 may be arranged in various configurations including varying components depending upon user or analyst preferences. In some embodiments, the front-end components 104 may include a plurality of client computing devices 110 configured to access information from the server 140 via the network 130 and to communicate information to the server 140. In an exemplary embodiment described in detail herein, the front-end components 102 and back-end components 104 may be used to facilitate a vehicle research and purchase process for users, during which information regarding user interactions with the servers 140 (e.g., data requests) or representatives associated with vehicle dealers may be recorded for analysis, which data collection may be voluntary or may require affirmative user consent, in various embodiments. Correspondingly, the client computing devices 110 may be used to obtain information from and provide information to the servers 140 regarding vehicles, vehicle dealers, user interactions with a vehicle dealer or data source (e.g., user research on a website providing vehicle data), and indications of user interest in specific vehicles or types of vehicles (e.g., user e-mail or chat messages regarding such vehicles). Each of these client computing devices 110 may request data regarding vehicles or vehicle dealers through a general-purpose or special-purpose software application running on the device, such as from a web browser, a data service application, or a messaging or voice communication application (e.g., via an automated or live communication session). The client computing devices 110 may obtain the data via the network 130 from a server 140, which server 140 may store information regarding the requests and user interactions. The server 140 may further acquire and store information regarding user requests or user locations, based upon data received from the client computing devices 110. Such data may include user communications indicating user data requests, user responses to information requests, or other information or requests sent by the user to a server 140 or other electronic device associated with a vehicle dealer or with a representative of a vehicle dealer. Such information may be processed by the server 140 to generate reports of user data interaction of users or predict probabilities of user actions. Such reports may be generated upon receipt of requests from analyst computing devices 114.

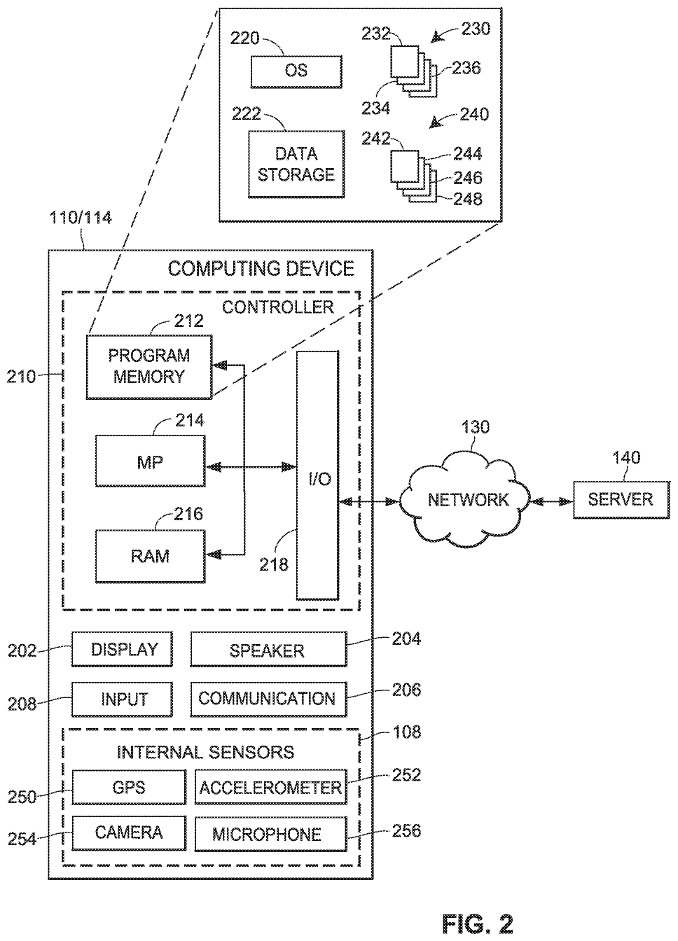

In various embodiments, the client computing devices 110 or analyst computing devices 114 may be any known or later-developed dedicated-use or general-use mobile personal computers, cellular phones, smartphones, tablet computers, or wearable computing devices (e.g., watches, glasses, etc.). For example, the client computing device 110 may be a general use smartphone or tablet computer with a web browser. In some embodiments, the client computing device 110 may be a thin client device, wherein much or all of the computing processes are performed by the server 140, with information communicated between the thin client device and the server 140 via the network 130. The client computing device 110 may include any number of internal components and may be further communicatively connected to one or more external components by any known wired or wireless means (e.g., USB cables, Bluetooth communication, etc.). An embodiment of the client computing device 110 and analyst computing device is further discussed below with respect to FIG. 2.

One or more routers 112 may be included within the data system 100 to facilitate communication. The routers 112 may be any wired, wireless, or combination wired/wireless routers using any known or here-after developed communication protocol for general- or special-purpose computer communication. In some embodiments, the client computing devices 110 or analyst computing devices 114 may be communicatively connected to the network 130 via one or more routers 112. Wireless communication may occur by any known means, such as Bluetooth, Wi-Fi, or other appropriate radio-frequency or other communications protocols.

The front-end components 102 communicate with the back-end components 104 via the network 130. The network 130 may be a proprietary network, a secure public internet, a virtual private network or some other type of network, such as dedicated access lines, plain ordinary telephone lines, satellite links, cellular data networks, combinations of these, etc. Where the network 130 comprises the Internet, data communications may take place over the network 130 via an Internet communication protocol.

The back-end components 104 include one or more servers 140. Each server 140 may include one or more computer processors within the controller 142 adapted and configured to execute various software applications and routines of the data system 100 stored in the program memory 144, in addition to other software applications. The controller 142 may include one or more processors (not shown), a random-access memory (RAM) (not shown), the program memory 144, and an input/output (I/O) circuit (not shown), all of which may be interconnected via an address/data bus (not shown). The RAM and program memory 144 may be implemented as semiconductor memories, magnetically readable memories, optically readable memories, or any other type of known or hereafter developed memory capable of storing executable instructions for execution by computer processors, such as the controller 142. The server 140 may further include one or more databases 146, which may be adapted to store data received from the front-end components 102, as well as data to be transmitted to the front-end components 102 (e.g., vehicle or vehicle dealer information). Such data might include, for example, information regarding vehicles listed for sale by vehicle dealers, information regarding average prices or ratings for vehicles of specified types, makes, models, or years, information regarding vehicle dealer inventory, hours, or customer ratings, or other information a customer may use in searching for or purchasing a vehicle. The server 140 may access data stored in the database 146 when executing various functions and tasks associated with the data system 100.

FIG. 2 illustrates a block diagram of an exemplary client computing device 110 or analyst computing device 114 in accordance with the data system 100. Because the analyst computing device 114 may, in some embodiments, be a desktop computer having additional or fewer components than the client computing device 110, the following description refers to the client computing device 110. It should be understood, however, that any combination of features described herein with respect to the client computing device 110 may be included in the analyst computing device 114.

The client computing device 110 may be a desktop computer, a notebook computer, a netbook computer, a smartphone, a tablet computer, or similar mobile or stationary computing device capable of receiving and processing electronic information. The client computing device 110 may include one or more internal sensors 108, which may provide sensor data regarding the local physical environment or the device's location therein. Such internal sensors 108 may likewise facilitate user input to the client computing device 110, such as by enabling the user to issue voice commands via a microphone 256. The client computing device 110 may further communicate with the server 140 via the router 112 and/or the network 130 to send and receive data. The data may be processed by the controller 210 to perform various operations for the user. Additionally, or alternatively, the data may be sent to one or more processors of the server 140 through the network 130 for processing. When the controller 210 (or other processor) receives an indication of a user action or request, appropriate responses are determined and implemented. Such responses may include processing data for presentation to the user, requesting data from the server 140, processing data from other front-end components 102 or back end components 104, determining information regarding the client computing device 110, sending data to the server 140, or presenting information to the user via a display 202 or speaker 204. In some embodiments, the client computing device 110 may include a communication unit 206 to send or receive information from local or remote devices (e.g., analyst computing device 114 or server 140), either directly or through the network 130. The communication unit 206 may include a wireless communication transceiver, such as a Wi-Fi or Bluetooth communication component. Further embodiments of the client computing device 110 may include one or more inputs 208 to receive instructions, selections, or other information from a user of the client computing device 110.

The client computing device 110 may include various input and output components, units, or devices. The display 202 and speaker 204, along with other integrated or communicatively connected output devices (not shown), may be used to present information to the user of the client computing device 110 or others. The display 202 may include any known or hereafter developed visual or tactile display technology, including LCD, OLED, AMOLED, projection displays, refreshable braille displays, haptic displays, or other types of displays. The one or more speakers 204 may similarly include any controllable audible output device or component, which may include a haptic component or device. In some embodiments, communicatively connected speakers 204 may be used (e.g., headphones, Bluetooth headsets, docking stations with additional speakers, etc.). The input 208 may further receive information from the user. Such input 208 may include a physical or virtual keyboard, a microphone, virtual or physical buttons or dials, or other means of receiving information. In some embodiments, the display 202 may include a touch screen or otherwise be configured to receive input from a user, in which case the display 202 and the input 208 may be combined.

The client computing device 110 may further include various internal sensors 108. The internal sensors 108 may include any devices or components mentioned herein, other extant or later-developed devices suitable for monitoring a physical environment (including device position or location within the environment). The sensors of the client computing device 110 may further include additional internal sensors 108 specifically configured for determining location or for tracking movement or spatial orientation of the device.

Although discussion of all possible sensors of the client computing device 110 would be impractical, if not impossible, several sensors warrant particular discussion. Disposed within the client computing device 110, the internal sensors 108 may include a GPS unit 250, an accelerometer 252, a camera 254, or a microphone 256. Any or all of these may be used to generate sensor data regarding the client computing device 110, its environment, user activity, or other relevant information. Additionally, other types of currently available or later-developed sensors may be included in some embodiments.

The GPS unit 250, the accelerometer 252, and the gyroscope 258 may provide information regarding the location or movement of the client computing device 110. The GPS unit 250 may use “Assisted GPS” (A-GPS), satellite GPS, or any other suitable global positioning protocol (e.g., the GLONASS system operated by the Russian government) or system that locates the position of the client computing device 110. For example, A-GPS utilizes terrestrial cell phone towers or Wi-Fi hotspots (e.g., wireless router points) to more accurately and more quickly determine location of the client computing device 110, while satellite GPS generally is more useful in more remote regions that lack cell towers or Wi-Fi hotspots.

The accelerometer 252 may include one or more accelerometers positioned to determine the force and direction of movements of the client computing device 110. In some embodiments, the accelerometer 252 may include a separate X-axis accelerometer, Y-axis accelerometer, and Z-axis accelerometer to measure the force and direction of movement in each dimension respectively. It will be appreciated by those of ordinary skill in the art that a three dimensional vector describing a movement of the client computing device 110 through three dimensional space can be established by combining the outputs of the X-axis, Y-axis, and Z-axis accelerometers using known methods. In some embodiments, one or more accelerometers 252, gyroscopes, or similar sensors may be disposed within a wearable device associated with a user, such that the sensor data therefrom may indicate movement of the user. Such sensor data may further be used to determine relative movements of the user over time. For example, movement data may be used to determine the length of time a user spends at a particular location, such as examining a particular vehicle on a vehicle dealer lot.

The camera 254 may be used to capture images of vehicles or other relevant objects in the user's environment. It should be understood that one or more cameras 254 may be disposed within the client computing device 110 and configured to generate either still images or video recordings. It should further be understood that many smartphones or tablet computers include front and back solid state digital cameras, which may be used to simultaneously obtain images of a large portion of the area before and behind the phone or tablet. In some embodiments, the camera 254 may include a flash or lighting device to illuminate the subject area. The microphone 256 may be used to monitor sounds within the local physical environment 106. One or more microphones 256 may be disposed within the client computing device 110 or may be communicatively connected thereto. The one or more microphones 256 may be used to record sounds or to receive voice commands from a user.

The client computing device 110 may also communicate with the router 112 or the network 130 using the communication unit 206, which may manage communication between the controller 210 and external devices. The communication unit 206 may transmit and receive wired or wireless communications with external devices, using any suitable wireless communication protocol network, such as a wireless telephony network (e.g., GSM, CDMA, LTE, etc.), a Wi-Fi network (802.11 standards), a WiMAX network, a Bluetooth network, etc. Additionally, or alternatively, the communication unit 206 may also be capable of communicating using a near field communication standard (e.g., ISO/IEC 18092, standards provided by the NFC Forum, etc.). Furthermore, the communication unit 206 may provide input signals to the controller 210 via the I/O circuit 218. The communication unit 206 may also transmit sensor data, device status information, control signals, or other output from the controller 210 to one or more of the router 112, the network 130, or the server 140.

The client computing device 110 may further include a controller 210. The controller 210 may be configured to receive, process, produce, transmit, and store data. The controller 210 may include a program memory 212, one or more microcontrollers or microprocessors (MP) 214, a random access memory (RAM) 216, and an I/O circuit 218. The components of the controller 210 may be interconnected via an address/data bus or other means. It should be appreciated that although FIG. 2 depicts only one microprocessor 214, the controller 210 may include multiple microprocessors 214 in some embodiments. Similarly, the memory of the controller 210 may include multiple RAM 216 or multiple program memories 212. Although the FIG. 2 depicts the I/O circuit 218 as a single block, the I/O circuit 218 may include a number of different I/O circuits, which may be configured for specific I/O operations. The microprocessor 214 may include one or more processors of any known or hereafter developed type, including general-purpose processors or special-purpose processors. Similarly, the controller 210 may implement the RAM 216 and program memories 212 as semiconductor memories, magnetically readable memories, optically readable memories, or any other type of memory.

The program memory 212 may include an operating system 220, a data storage 222, a plurality of software applications 230, and a plurality of software routines 240. The operating system 220, for example, may include one of a plurality of mobile platforms such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage 222 may include data such as user profiles and preferences, application data for the plurality of applications 230, routine data for the plurality of routines 240, and other data necessary to interact with the server 140 through the digital network 130. In some embodiments, the controller 210 may also include, or otherwise be communicatively connected to, other data storage mechanisms (e.g., one or more hard disk drives, optical storage drives, solid state storage devices, etc.) that reside within the client computing device 110. Moreover, in thin-client implementations, additional processing and data storage may be provided by the server 140 via the network 130.

The software applications 230 and routines 240 may include computer-readable instructions that cause the processor 214 to implement data processing and communication functions. Thus, the software applications 230 may include a vehicle information application 232 to obtain and present information regarding vehicles and vehicle dealers, a web browser application 234 to obtain and present web-based content, or a reporting application 236 to generate or present based upon user interactions. The software routines 240 may support the software applications 230 and may include routines such as a voice communication routine 242 to establish and maintain a voice communication connection, a communication routine 244 for communicating with the server 140 via the network 130, a data request routine 246 to allow a user to specify parameters for requesting data, and a data presentation routine 248 for generating or presenting received data to the user via the display 202. It should be understood that additional or alternative applications 230 or routines 240 may be included in the program memory 212, including other applications of the sort ordinarily stored on a mobile devices.

In some embodiments, the client computing device 110 may include a wearable computing device or may be communicatively connected to a wearable computing device. In such embodiments, part or all of the functions and capabilities of the client computing device 110 may be performed by or disposed within the wearable computing device. Additionally, or alternatively, the wearable computing device may supplement or complement the client computing device 110. For example, the wearable computing device 110 may be a smart watch with a display 202, a speaker 204 (or haptic alert unit), an input 208, and one or more internal sensors 108. Such smart watch may be communicatively connected to a smartphone and used interchangeably with the smartphone for some purposes (e.g., displaying information, providing user alerts, etc.).

The data system 100 described above and illustrated in FIGS. 1-2 may be used to perform the various user interaction monitoring, analysis, prediction, and reporting methods discussed further below. Together, the methods described below relate to prediction of user actions based upon interaction data, including communication between a user and a resource provider (e.g., between a consumer and a vehicle dealer representative). Although the methods are described with reference to vehicles and vehicle dealers, the methods may be applied to other situations in which users interact with electronic data sources or with resource providers via electronic communications.

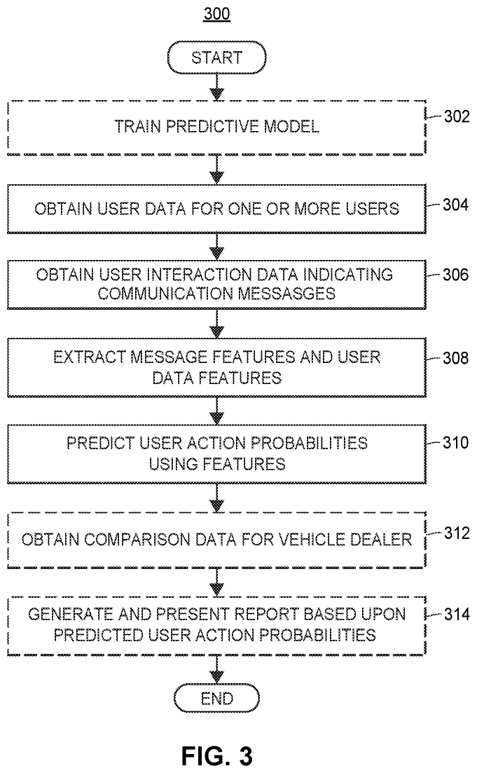

FIG. 3 illustrates a flow diagram of an exemplary predictive analytics method 300 for predicting, analyzing, and reporting likelihood of actions by users based upon user interaction data. The method 300 may be implemented by one or more servers 140 of the data system 100 to generate predictions of user actions based upon user interaction data. The user interaction data includes at least one message sent from a user of an electronic system (e.g., a client computing device 110) to a recipient associated with the predicted user action (e.g., a user of an analyst computing device 114). To illustrate the operation of the process, the user is described herein as a consumer interacting with a vehicle dealer via electronic communications, and the predicted user action is described as an action of purchasing a vehicle within a predetermined time interval following such communication. Such aspects are exemplary, and the techniques disclosed herein may be applied to additional or alternative scenarios beyond those described in the exemplary embodiments of the exemplary predictive analytics method 300.

The predictive analytics method 300 may begin, in some embodiments, with training a predictive model for use in predicting user actions (block 302). Once a predictive model has been trained or otherwise selected, user data associated with a user of an electronic system is obtained (block 304). User interaction data indicating communication between the user and a vehicle dealer system or representative is then obtained (block 306). Message features are extracted from the user interaction data, and user data features are extracted from the user data (block 308). The predictive model is then applied to the extracted features to predict a user action probability for the user (block 310). In some embodiments, comparison data for the vehicle dealer may be obtained (block 312), which may further be used in generating and presenting a report based upon the predicted user action probability (block 314). In some embodiments, the exemplary method 300 may be modified to include alternative, additional, or fewer actions.

At block 302, in some embodiments, the server 140 may train a predictive model for generating probabilities of user actions based upon communication messages from users. The predictive model may be generated by training a machine learning model using a training data set comprising user interaction data and user action data to identify correlations between user interactions (e.g., user communication with vehicle dealers) and user actions (e.g., vehicle purchases by the corresponding users), as discussed further below. Alternatively, a previously defined predictive model may be accessed and used in predicting user actions.

At block 304, the server 140 may obtain user data relating to one or more users of an electronic system, such as data relating to user of an electronic vehicle inventory system by a plurality of consumers. Such user data may be identified with the one or more users based upon a user indicator, such as a user ID associated with a user account or another identifier linked to user communication (e.g., a user e-mail address, social media account handle, or phone number). The user data may include information from user account profiles, user interactions with electronic data sources (e.g., websites or mobile applications), or other types of information regarding a user or a user's past actions that may be relevant to predicting future actions of such user.

In some embodiments, the user data may include site interaction data regarding interactions of one or more users with one or more portions of a web site or a mobile application associated with a vehicle dealer. Such user interactions may include viewing a page on a website or mobile application presenting vehicle information for a specific vehicle or type of vehicle. For example, a user may have visited a plurality of web pages associated with a particular make and model of vehicle, indicating a specific interest in such vehicles and an increased likelihood of making a purchase. Alternatively, another user may have visited web pages associated with various types of vehicles, indicating an earlier stage in a search and a lower likelihood of making a purchase soon. Such site interaction data may be recorded in a user profile or collected in a user log (e.g., a web browser cookie) over a single search session or over multiple sessions. In further embodiments, the user data may include relevant information regarding the users, such as user demographic information. Such information may include a location associated with the user (e.g., a state, city, or other home or current location of a user), an income associated with the user, an age of the user, price preferences associated with the consumer (e.g., based upon user profile selections or search criteria), or prior vehicle purchases or leases by the consumer.

At block 306, the server 140 may obtain user interaction data relating to communication between the one or more users and a vehicle dealer, such as user inquiries regarding vehicles offered for sale by the vehicle dealer. The user interaction data indicates information regarding interaction of a user with a vehicle dealer representative via one or more messages, such as by sending a text-based message (e.g., an e-mail inquiry) or a voice message exchange (e.g., a telephone call). Such communication messages between the one or more users and the vehicle dealer representatives may be part of synchronous or asynchronous communication exchanges. In some embodiments, the user interaction data relating to communication may include message content of one or more messages and additional message metadata regarding the messages (e.g., metadata indicating the type, timing, method, or parties associated with a message). Thus, obtaining the user interaction data includes obtaining at least a message content of a message between a user and a vehicle dealer, and obtaining the user interaction data may further include obtaining additional metadata associated with the message. In various embodiments, the message content may be communication content in one or more of the following: an e-mail message sent from the user to an e-mail address associated with the vehicle dealer, an electronic chat message (e.g., an online chat on a vehicle dealer website or a short messaging service (SMS) text message exchange) from the consumer to a recipient associated with the vehicle dealer, or a transcript of an audio message from the user to a representative of the vehicle dealer (e.g., an automatically generated transcript of at least a portion of a phone call).

The user interaction data may be obtained by requesting, receiving, or accessing one or more user interaction records containing data regarding interactions between one or more users and one or more vehicle dealers. Such user interaction records may be retrieved from a database 146 for use in predicting user actions. In some embodiments, separate user interaction records may be obtained for each of the one or more users. In further embodiments, separate user interaction records may be obtained for each user interaction (e.g., for each e-mail or e-mail chain, for each electronic chat message or thread, or for each phone call or portion thereof). In such embodiments, each user interaction record may include an indication of the user (e.g., a user ID).

At block 308, the server 140 may extract feature data from the user data and the user interaction data. Extracting such feature data may include extracting message features from the message content associated with each of the messages in the user interaction data and extracting user data features from the user data. Each of the extracted features corresponds to an input category of the predictive model to be used to predict user action probabilities. Thus, the message features correspond to categories of input variables associated with user communication messages, and the user data features correspond to categories of input variables associated with other user data. In some embodiments, the extracted features may be derived from the user data or user interaction data, such as by categorizing, combining, or reformatting portions of the data. As discussed below, extracting the message features may include parsing the message content into a plurality of message features associated with key words, phrases, or grammatically significant structures, which may be formatted as separate message features associated with distinct portions of the message content. Similarly, extracting the user data features may include selecting relevant portions of the user data to use as inputs to the predictive model, which selected data may be appropriately processed and formatted to generate user data features. Depending upon the sources and structure of the obtained data, communication metadata may be extracted as either message features or user data features in various embodiments.

At block 310, the server 140 may apply the trained predictive model to the extracted feature data to generate a prediction of user actions for each of the one or more users. In some embodiments, this may include merging the message features and the user data features to produce an input data set for analysis by the predictive model. The combined feature data may be further prepared as complete and properly formatted input to the predictive model, in some embodiments, which may include adding blank or empty entries for missing fields in the input data set. Similarly, the input data set may be validated for out-of-range values or other errors prior to being input into the predictive model. In some embodiments, additional data may be added to the input data set prior to analysis, such as data regarding factors affecting all users in the data set (e.g., factors such as location, advertising campaigns, or other features associated with the vehicle dealer). In further embodiments, the input data set may be limited to users for whom sufficient data is available for analysis by the predictive model (e.g., users with a minimum set of message features derived from at least on communication message), with records pertaining to other users removed from the input data set prior to analysis. The predictive model is then used to generate one or more predicted actions of the one or more users based upon the input data set, including the message features and the user data features.

Thus, the predictive model generates one or more output values for each of the one or more users, each predicting a future user action based at least in part upon an implicit user intent associated with features extracted from the user data and from the interaction data (i.e., the user data features and message features). In this way, the predictive model generates output variables indicative of user intent from observed user actions and user communication. Such output variables may include probability predictions of future actions meeting predefined criteria, such as taking a specified action within a predefined time interval following a reference time (e.g., a time of the analysis using the predictive model or a time of one or more user interactions, such as a time of the most recent user communication message). For example, an output variable may indicate the probability of a user purchasing a vehicle within three days following a most recent communication message, while other exemplary output variables may indicate the probability of the user purchasing a particular type of vehicle (e.g., a new vehicle, a used vehicle, or a vehicle having a particular vehicle year, model, or price range) or purchasing a vehicle from the vehicle dealer within such time interval. In further embodiments, the output variables may instead indicate predicted statistical behavior of the users, such as a predicted average time from the most recent communication message to a vehicle purchase decision by the user or times associated with other percentiles or ranges.

At block 312, in some embodiments, the server 140 may obtain comparison data for the vehicle dealer related to the predicted user actions. Such comparison data may be used for baseline metrics or context in a report concerning the predicted user actions. For example, the comparison data may include metrics regarding average contacts or sales for the vehicle dealer or average sales prices of vehicles associated with the predicted user actions for the users (e.g., expected purchase prices of vehicles associated with user communications). Such comparison data may similarly include data from which additional metrics may be generated. For example, an average vehicle cost to the dealer or an average sales price for relevant vehicles may be used to generate an average profit from a user action of purchasing a vehicle from the vehicle dealer. The comparison data may further include a cost associated with providing information to the users, such as staffing or technology costs. As an example, the costs of providing information may include costs associated with an advertising campaign (e.g., a total cost or an average cost per user in the input data set), which may be used to compare the expected value of the user actions based upon the user action predictions against the cost of generating user leads in order to evaluate the effectiveness or value to the vehicle dealer of the advertising campaign.

At block 314, in some embodiments, the server 140 may generate and present a report based upon the predicted user actions. The report may be generated for and presented to a reviewer or analyst associated with the vehicle dealer in order to evaluate the predicted user actions. Therefore, the report may include indications of the predicted user actions, such as the probabilities of the users taking the specified actions within specified parameters (e.g., probabilities of users purchasing vehicles within a predefined time interval). Such indications of the predicted user action probabilities may be included in the report as the actual probabilities, categories of such probabilities (e.g., percentile-based groupings of whether each user is likely or unlikely to take a specified action within the specified parameters), or as summary or derivative information based upon the predicted user action probabilities. Thus, in some embodiments, the report may include comparison information based upon the predicted user action probabilities. Such comparison information may include profit metrics relating to a comparison of the vehicle dealer's costs associated with selling a vehicle and the expected values of the user actions relating to vehicle purchases by the user, based upon the probabilities of the users purchasing vehicles from the vehicle dealer and the expected sales prices or profit on such sales. In some examples, the report may include a comparison of vehicle dealer costs with estimated values associated with each of the one or more users indicating an expected value of a vehicle purchase by the respective user (based on the expected purchase price and the probability of the user purchasing the vehicle from the vehicle dealer within a predetermined time interval).

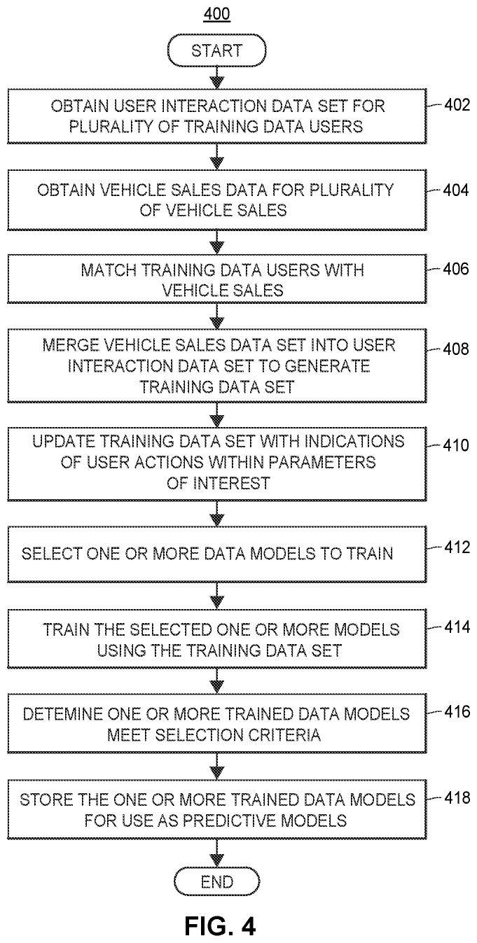

FIG. 4 illustrates a flow diagram of an exemplary model training method 400 for generating a predictive model of user actions. The model training method 400 may be implemented by one or more servers 140 of the data system 100 to generate a predictive model in block 302 of the predictive analytics method 300 discussed above, using the same or different servers 140. The model training method 400 or another similar method may be implemented in advance of user interactions in order to obtain one or more models for predicting user actions based upon user communications. Such trained predictive models may be stored for later use in predicting user actions.

The model training method 400 begins by obtaining a user interaction data set for a plurality of users (block 402) and a vehicle sales data set for a plurality of vehicle sales (block 404). The users in the user interaction data set are then matched with sales in the vehicle sales data set (block 406), and the vehicle sales data set is merged into the user interaction data set to produce a training data set (block 408). In some embodiments, the training data set may further be updated with indications of user actions within relevant parameters (e.g., vehicle purchases within a specified time interval following a user interaction) (block 410). One or more data models are selected for training on the training data set (block 412) and are trained using the training data set (block 414), until one or more trained data models meet selection criteria (block 416). The one or more successfully trained data models are then stored as predictive models for further use in predicting user actions (block 418). In some embodiments, the exemplary method 400 may be modified to include alternative, additional, or fewer actions.

At block 402, the server 140 may obtain a user interaction data set for training a predictive model. The user interaction data set includes training data associated with a plurality of training data users, which may comprise interaction data entries associated with the training data users. Such interaction data entries may include message features and user data features associated with respective training data users. For example, an interaction data entry may include information associated with a specific communication between a particular training data user and a vehicle dealer, which may include message content and metadata. In some embodiments, the interaction data entries may include other user data associated with the user or with site interactions by the user, as discussed above. The interaction data entries may include either processed message data (i.e., message features derived from a message) or unprocessed message data (i.e., message content or message metadata). In the case of unprocessed message data, the server 140 may first process the message data to generate the message features for further use in training the predictive model. The user data features may likewise be obtained and associated with the interaction data entries in the user interaction data set.

At block 404, the server 140 may obtain a purchase data set comprising vehicle sales data for training the predictive model. The purchase data set may include a plurality of purchase data entries containing the vehicle sales data, with each purchase entry including purchase data features associated with a particular vehicle sale. Such purchase data features may include information regarding the vehicle type, condition, make, model, year, vehicle optional features, sale price, sale date, sale location, vehicle identification number (VIN), vehicle dealer information, buyer information, or other information related to the vehicle sale. The purchase data set may be obtained from one or more third party, which may include public records, and the vehicle sales data may be processed to extract or generate the purchase data features in a standardized format for use in training the predictive model.

At block 406, the server 140 may match training data users in the user interaction data set with vehicle sales in the purchase data set. The training data users may be matched with vehicle purchasers indicated in each purchase entry. Alternatively, the training data users may be matched with sales based upon a VIN or other unique identifier of a vehicle or of a vehicle sale, which identifiers may be further matched with purchasers using additional data. The training data users and the vehicle sales may be matched to the extent possible using the available data, such that not all training data users will be matched with a vehicle sale (e.g., due to some users not purchasing a vehicle). Additionally, some vehicle sales may not be matched with training data users (e.g., due to vehicles being sold to other purchasers not having user interactions in the user interaction data set).

At block 408, the server 140 may then merge the vehicle sales data into the user interaction data set to generate a training data set. Such merge may be based upon the matches between the training data users associated with the interaction data entries and the vehicle sales associated with the purchase entries. The training data set may comprise a plurality of training data entries connecting user interaction data with information regarding any identified vehicle purchases by corresponding training data users. Thus, in some embodiments, each training data entry includes (i) a plurality of message features from the corresponding interaction data entry, (ii) one or more user data features from the corresponding interaction data entry, and/or (iii) an indication of vehicle purchase data. Such indication of vehicle purchase data may include either one or more purchase features from the corresponding purchase data entry or an indication of no corresponding purchase data entry being found in the purchase data set. In some such embodiments, the indication of no corresponding purchase may simply be null or empty fields in the training data entry.

At block 410, in some embodiments, the server 140 may further update the training data set by adding indications of user actions within predetermined parameters of interest (e.g., purchasing a vehicle within a time interval following a user interaction or site interaction). This may include determining a time between a message or other user interaction indicated by a training data entry and a vehicle purchase associated with such training data entry. Training data entries without corresponding vehicle purchases would not meet the criteria of a user action within the parameters of interest, but some vehicle purchases may also not meet the criteria. Thus, training data entries indicating a vehicle purchase after a predetermined interval of interest or indicating a purchase of a different type of vehicle or a purchase from a different vehicle dealer may also be determined not to meet the criteria of interest. Once each training data entry has been analyzed with respect to one or more sets of user actions within parameters of interest, an indication of whether such criteria are met may be added to the training data entry. In some embodiments, multiple sets of such criteria relating to user actions within specified parameters of interest may be analyzed and indicated in the training data set.

At block 412, the server 140 may select one or more untrained data models to train using the training data set. The selected data models may include any type of untrained machine learning models for supervised or unsupervised learning. A model may be specified based upon user input specifying relevant parameters to use as predicted variables (e.g., indications of user actions meeting parameters of interest, vehicle purchases, or time of vehicle purchase following a message) and other variables to use as potential explanatory variables (e.g., message features or user data features). For example, a model may be specified to predict the whether a user will purchase a particular type of vehicle based upon message features and other user data. Conditions for training the predictive model may likewise be selected, such as limits on model complexity or limits on model refinement past a certain point. Because outcomes may vary significantly by location or vehicle type, the models may also be selected to specify location (e.g., state or metropolitan area) or vehicle type (e.g., new/used, make, vehicle category, or price range). In some embodiments, unsupervised machine learning techniques may be used to determine the relevant geographic locations or vehicle types based upon the training data set.

At block 414, the server 140 may train the selected one or more untrained data models using the training data set. To train the data models, the server 140 may randomly select a first subset of the training data entries to use in generating a trained data model. The selected data model may then be trained on the first subset of training data entries using appropriate machine learning techniques, based upon the type of model selected and any conditions specified for training the model. The model may be trained using a supervised or unsupervised machine-learning program or algorithm. The machine-learning program or algorithm may employ a neural network, which may be a convolutional neural network, a deep learning neural network, or a combined learning module or program that learns in two or more features or feature datasets in a particular areas of interest. The machine-learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine-learning algorithms and/or techniques. Machine-learning may involve identifying and recognizing patterns in existing data in order to facilitate making predictions for subsequent data. In some embodiments, due to the processing power requirements of training machine learning models, the selected model may be trained using additional computing resources (e.g., cloud computing resources) based upon data provided by the server 140. Such training may continue until at least one model is validated and meets selection criteria to be used as a predictive model.

At block 416, the server 140 may determine that one or more trained data models meet selection criteria to be selected as a predictive model for further analysis of user interaction data. Thus, each trained data model may be validated using a second subset of the training data records to determine model accuracy and robustness. Such validation may include applying the trained model to the training data records of the second subset of training data records to predict values of some of the user action values of such records or output metrics derived from such records (e.g., data values associated with vehicle purchases or lack thereof). The trained model may then be evaluated to determine whether the model performance is sufficient based upon the validation stage predicted values. The sufficiency criteria applied may vary depending upon the size of the training data set available for training, the performance of previous iterations of trained models, or user-specified performance requirements.

When the server 140 determines the trained model has not achieved sufficient performance, additional training may be performed at block 414, which may include refinement of the trained model or retraining on a different first subset of the training data records, after which the new trained model may again be validated and assessed at block 416. When the server 140 determines the trained model has achieved sufficient performance at block 416, the trained model may be stored for later use.

At block 418, the server 140 may store the one or more selected trained data models for later use as predictive models according to the methods and techniques disclosed herein. The trained predictive models may be stored as sets of parameter values or weights for analysis of further user interaction data or user data, which may also include analysis logic or indications of model validity in some instances. Thus, a plurality of models may be stored for predicting user actions under different sets of input data conditions (e.g., locations or vehicle types). In some embodiments, trained predictive models may be stored in the database 146 associated with server 140.

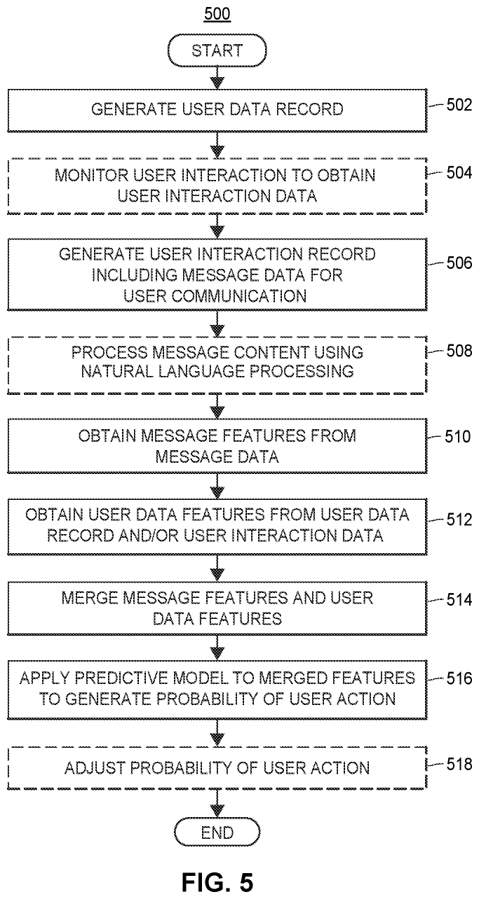

FIG. 5 illustrates a flow diagram of an exemplary user action prediction method 500 for predicting a probability of a user action using message data from user communications. The user action prediction method 500 may be implemented by one or more servers 140 of the data system 100 to monitor and predict user actions according to the predictive analytics method 300 discussed above. In some embodiments, the method 500 may monitor and record user messages, while in other embodiments such messages may be obtained from another system for analysis. As noted above, such messages may comprise inquiries from vehicle shoppers to vehicle dealers regarding specific vehicles or general information associated with the vehicle dealer.

The user action prediction method 500 may begin by generating a user data record for a user of an electronic system (block 502), such as a user account record. In some embodiments, user interaction with the electronic system may be monitored to obtain additional user interaction data (block 504). Following user communication, a user interaction record is generated that includes message data for the user communication (block 506). In some embodiments, the message content is processed using natural language processing techniques to identify message structure (block 508). Message features are then obtained from the message data (block 510), and user data features are obtained from the user data record or the user interaction data (block 512). The message features and user data features are merged (block 514) and analyzed using the predictive model to generate an estimate of a probability of a user action (block 516). In some embodiments, the estimated probability of the user action may further be adjusted to account for other relevant factors (block 518). In some embodiments, the exemplary method 500 may be modified to include alternative, additional, or fewer actions.

At block 502, the server 140 may generate a user data record for a user of an electronic system, such as a vehicle dealer website or application. The user data record includes user data and an indication of the user to identify the user (e.g., a user ID). Such user data record may include a user profile or user account record for the user. In some embodiments, the user data record may include information identifying the user, while other embodiments may lack user-identifying information. Additionally or alternatively, the user data record may include user data comprising demographic data regarding the user, part or all of which may be obtained from additional data sources. Such user demographic data may include one or more of the following: a location associated with the user, an income associated with the user, an age of the user, price preferences associated with the consumer, or prior vehicle purchases or leases by the consumer.

At block 504, in some embodiments, the server 140 may monitor interactions of the user with a vehicle dealer to obtain user interaction data. The user interactions may include communication interactions (e.g., communication messages or exchanges) or site interactions (e.g., website or application usage). The communication interactions may be obtained as user interaction data, while the site interactions may be obtained as site interaction data. The user interaction data may be related to any type of communication including a written or spoken message from the user to a vehicle dealer representative. Thus, the user interaction data includes message content and message metadata associated with one or more electronically transmitted messages. In some embodiments, the message content may comprise communication content within an e-mail message sent by the user to an e-mail address associated with the vehicle dealer. In further embodiments, the message content may comprise communication content within an electronic chat message from the user to a recipient associated with the vehicle dealer. In still further embodiments, the message content may comprise communication content within an audio message from the user to a representative of the vehicle dealer, such as a voice call (e.g., a phone call) or an audio portion of a video call. In such embodiments, the audio may be processed to generate a transcript of at least a portion of the audio communication as an audio message. The site interaction data may include data regarding interaction of the user with one or more portions of a web site or a mobile application associated with the vehicle dealer, such a user clicks, view, searches, or other types of interaction with an electronic information system. For example, the site interaction data may include information regarding user requests for data regarding particular vehicles (e.g., viewing vehicle data pages for a particular vehicle for sale by a vehicle dealer).

At block 506, the server 140 may generate a user interaction record associated with user communication. The user interaction record includes the message content of at least one communication message from the user to the vehicle dealer. The user interaction record may be included in the user data record or may be generated as a separate record including an indication of the user to link the user interaction record to the user data record. In some embodiments, the user interaction message may include user data, such as site interaction data. The user interaction records may be stored in the database 146, either together with or separate from the user data records.

At block 508, in some embodiments, the server 140 may preprocess or partially the message content of the user interaction record using natural language processing techniques to identify relevant structures, syntax, and categories of parts of the message content. Such natural language processing may include identifying words, phrases, or groups of words sharing common attributes, such as roots or general meanings. Such information may be used to improve the consistency of message feature extraction.

At block 510, the server 140 may obtain message features from the message data in the user interaction record. The message features may be obtained by parsing the message content based upon logic associating text strings of the message content with input categories used by the predictive model. If natural language processing had been used to preprocess the message content, the results of such natural language processing may be parsed to produce the message features. In addition to the message content, message metadata may also be parsed to extract or generate additional message features for analysis. The input categories associated with the message features may be related to features that may be extracted from the message content, such as vehicle type, inquiry type (e.g., general inquiries, vehicle availability, vehicle dealer information inquiries, or vehicle price), detail type (e.g., low level of detail or high level of detail), message length, message tone, or other such categories. Thus, obtaining the message features may include extracting the message features by parsing the message content into a plurality of message features, which may be formatted as separate message features associated with distinct portions of the message content.

At block 512, the server 140 may obtain user data features from either the user data record or from the site interaction data of the user interaction data. In some embodiments, user data features may be extracted from the user data record directly by extracting data fields of the user data record relating to categorized user information (e.g., user location area, user age group, or user income group). Additional or alternative user data features may be extracted from the user data record by identifying and categorizing user-related information stored in the user data record (e.g., user age group may be determined based upon user date of birth). In further embodiments, user data features relating to user interaction with a website or application may be obtained or generated based upon site interaction data (e.g., user time spent viewing information on a vehicle data page associated with a particular vehicle or user actions to view additional information regarding a vehicle or regarding vehicle incentives or financing). Thus, extracting the user data features may include selecting relevant portions of the user data to use as inputs to the predictive model, which selected data may be appropriately processed and formatted to generate user data features.

At block 514, the server 140 may merge the message features and the user data features associated with the user into an input data set providing the relevant data for analysis by a predictive model. The input data set indicates relevant user information and indications of user interactions with vehicle dealer representatives or information systems, and such information is properly formatted for analysis by a predictive model. Thus, the input data set includes all the input data needed by the predictive model to predict the user action (e.g., to predict a probability of the user purchasing a vehicle within parameters of interest).

At block 516, the server 140 may apply the predictive model to the merged features of the input data set to generate an output value indicating a probability of a user action, such a purchasing a vehicle from the vehicle dealer within a predetermined time interval. The previously trained predictive model may be used to generate one or more output values based upon the input data set, which output values may indicate predictions regarding future actions by the user. For example, a first output may indicate a probability of the user purchasing a vehicle within a predetermined time interval following a communication message, which a second output may indicate a probability of the user making the vehicle purchase from the contacted vehicle dealer. Other output values may indicate expected vehicle purchase price or vehicle features, probabilities of the user purchasing a vehicle within other time intervals, or the probability of the user initiating or responding to further communication with the vehicle dealer.

At block 518, in some embodiments, the server 140 may adjust the predicted probability of the user action. Such adjustments may be made when additional probability predictions based upon additional user interactions with the vehicle dealer are available. For example, a user may send multiple e-mails to a vehicle dealer, each of which may be separately analyzed. Continuing the example, the user may then place a phone call to the vehicle dealer to confirm information, check that the vehicle is still available, check vehicle dealer hours, or schedule an appointment to meet with a vehicle dealer representative. The predictive probability may be adjusted by separately generating a second predicted probability of the user action using a second input data set based upon the later communication, then calculating a combined probability of the user action based upon the first and second predicted probabilities. Such combined probability may be greater than, less than, or equal to any of the individual predicted probabilities in various examples. In some embodiments, predictions of user actions may be updated based upon the passage of time or events (e.g., the expiration of a temporary discount available during a sale or the passage of a holiday weekend). In further embodiments, information regarding user interactions with other vehicle dealers may be used to adjust the predicted probability of a user action.

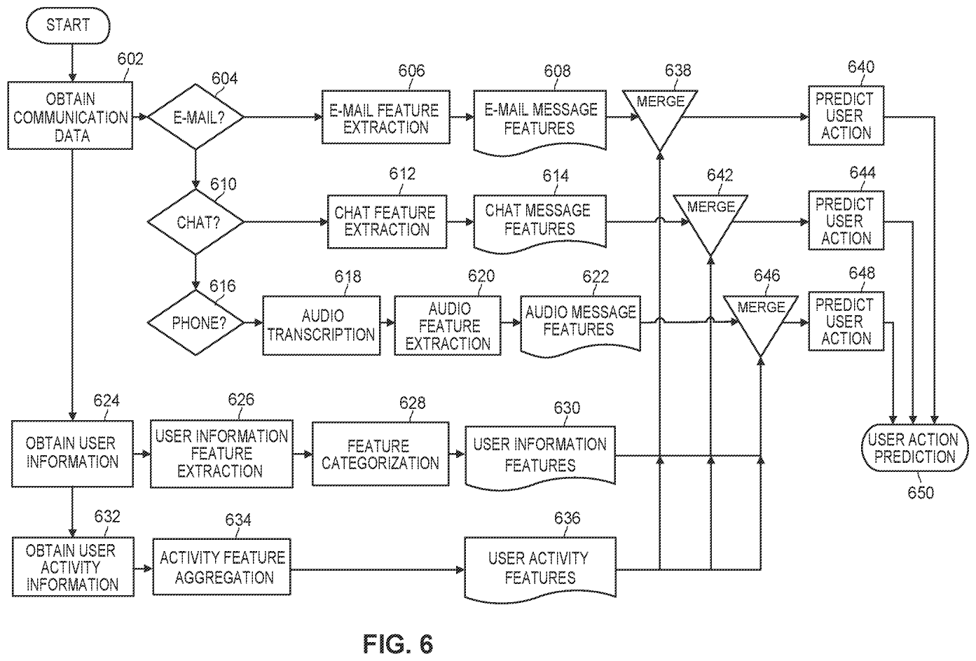

FIG. 6 illustrates a flow diagram of an exemplary vehicle purchase prediction method 600 for predicting a probability of a consumer purchasing a vehicle based upon interaction with a vehicle dealer. The vehicle purchase prediction method 600 may be implemented by one or more servers 140 of the data system 100 to monitor and predict user actions relating to vehicle purchases according to the predictive analytics method 300 discussed above. In some embodiments, the method 600 may monitor and record user messages, while in other embodiments such messages may be obtained from another system for analysis. Although the exemplary method 600 illustrates three types of user interaction messages (i.e., e-mail message, chat message, and voice call message), it should be understood that further types of communication messages may be similarly analyzed to predict user actions in additional embodiments.

The vehicle purchase prediction method 600 begins with obtaining communication data associated with electronic communication between a user (block 602), such as a consumer communicating with a vehicle dealer regarding a vehicle to purchase. Such communication data may include content data and/or metadata, which may be transmitted via electronic mail, electronic chat, or a voice or video call. In some embodiments, multiple communication messages (or the same or different types) may be obtained for the same user, which may include multiple messages or segments of communication between the user and the vehicle dealer (e.g., one or more vehicle dealer representatives). For any e-mail message that is identified in the communication data (block 604), the server 140 extracts e-mail features from the e-mail (block 606), which may include message content and metadata. The extracted e-mail features are further processed to obtain e-mail message features (block 608), which are message features as discussed elsewhere herein. Similarly, for any chat message that is identified (block 610), the server 140 extracts chat features from one or more chat messages of an electronic chat session (block 612), which may also include message content and metadata. The extracted chat features are then processed to obtain e-mail message features (block 608), which are message features as discussed elsewhere herein. For any phone or other voice messages identified in the communication data (block 616), the server 140 transcribes the audio data (block 618) prior to performing audio feature extraction (block 620) to obtain message content and metadata. Thus, the server 140 may generate a transcript of at least a portion of the voice call between the user and a representative of the vehicle dealer, with the transcript comprising the communication content within the audio message. The extracted audio message features are then processed to obtain audio message features (block 622), which are message features as discussed elsewhere herein.

In addition to communication data, the server 140 may obtain user information (block 624), such as user profile information regarding the user. The user information is then processed to extract user information features (block 626), which may be categorized into feature categories (block 628). The feature categories may be used to generate user information features associated with the user (block 630). Additionally, the server 140 may obtain user activity information (block 632), such as site interaction data regarding user interaction with a website or application. The activity information may be aggregated into activity features indicating trends, paths, or session metrics of user interaction (block 634), from which user activity features may be extracted or generated (block 636). The user information features and user activity features may be combined in some embodiments into user data features.

The message features and user data features may then be merged and used to predict a user action. Thus, any e-mail message features may be merged with any user information features and user activity features (block 638), which merged data may be analyzed using a previously trained predictive model to generate a prediction of a user action (block 640). Similarly, any chat message features may be merged with any user information features and user activity features (block 642), which merged data may be analyzed using a previously trained predictive model to generate a prediction of a user action (block 644). Finally, any audio message features may be merged with any user information features and user activity features (block 646), which merged data may be analyzed using a previously trained predictive model to generate a prediction of a user action (block 648). The user action predictions associated with each of the one or more messages may then be combined or used to adjust a predicted user action (e.g., to produce a combined probability based upon multiple messages) of interest (block 650). Generating the combined user action prediction may include calculating a combined probability of the user taking the specified action (e.g., purchasing a vehicle from a particular vehicle dealer within a predefined time interval following communication with the vehicle dealer).

### OTHER CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for systems and methods according to the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Although the foregoing text sets forth a detailed description of numerous different embodiments, it should be understood that the legal scope of the invention is defined by the words of the claims set forth at the end of this patent. The particular features, structures, or characteristics of any specific embodiment may be combined in any suitable manner and in any suitable combination with one or more other embodiments, including the use of selected features without corresponding use of other features. It is to be understood that other variations and modifications of the embodiments of the present invention described and illustrated herein are possible in light of the teachings herein and are to be considered part of the spirit and scope of the present invention. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A computer-implemented method for predicting user actions based upon user interaction, comprising:
receiving, at one or more processors, a consumer interaction record containing a message content of a message from a consumer to a vehicle dealer and an indication of the consumer;
parsing, by the one or more processors, the message content into a plurality of message features corresponding to input categories of a predictive model;
obtaining, by the one or more processors, user data associated with the consumer based upon the indication of the consumer;
extracting, by the one or more processors, user data features corresponding to further input categories of the predictive model from the user data;
merging, by the one or more processors, the user data features and the message features to generate an input data set indicating interaction between the consumer and the vehicle dealer;
generating, by the one or more processors, an output value by applying the predictive model to the input data set, the output value indicating a probability of the consumer taking a specified action associated with the vehicle dealer within a predefined time interval; and
presenting, by a display, a report including an indication of the probability of the consumer taking the specified action associated with the vehicle dealer within the predefined time interval.

2. The computer-implemented method of claim 1, further comprising:
receiving, at the one or more processors, a second consumer interaction record containing a second message content from the consumer to the vehicle dealer and a second indication of the consumer;
parsing, by the one or more processors, the second message content into a plurality of second message features corresponding to input categories of the predictive model;
merging, by the one or more processors, the user data features and the second message features to generate a second input data set indicating interaction between the consumer and the vehicle dealer;
generating, by the one or more processors, a second output value by applying the predictive model to the input data set, the second output value indicating a second probability of the consumer taking the specified action associated with the vehicle dealer within the predefined time interval; and
calculating, by the one or more processors, a combined probability of the consumer taking the specified action associated with the vehicle dealer within the predefined time interval based upon the probability and the second probability,
wherein the indication of the probability included in the report is based upon the combined probability of the consumer taking the specified action associated with the vehicle dealer within the predefined time interval.

3. The computer-implemented method of claim 1, wherein the specified action comprises purchasing a vehicle from the vehicle dealer, and further comprising generating the predictive model by:
obtaining, by the one or more processors, a user interaction data set comprising a plurality of interaction data entries, each interaction data entry including a plurality of message features and user data features associated with a user interaction of a training data user with a training data vehicle dealer;
obtaining, by the one or more processors, a purchase data set comprising a plurality of purchase data entries associated with vehicle purchases, each purchase data entry including a plurality of purchase features;
merging, by the one or more processors, the purchase data entries with the interaction data entries based upon training data user identifiers to generate a training data set comprising a plurality of training data entries, each training data entry including (i) the plurality of message features from the corresponding interaction data entry, (ii) one or more user data features from the corresponding interaction data entry, and (iii) either one or more purchase features from the corresponding purchase data entry or an indication of no corresponding purchase data entry being found in the purchase data set;
selecting, by the one or more processors, one or more untrained data models for predicting a probability of an outcome based upon input variables;
training, by the one or more processors, the one or more untrained data models using the training data set to obtain corresponding one or more trained data models;
determining, by the one or more processors, that one of the one or more trained data models meets selection criteria; and
selecting, by the one or more processors, the trained data model as the predicting model.

4. The computer-implemented method of claim 1, wherein parsing the message content comprises applying a natural language processing model to the message content to generate the message features.

5. The computer-implemented method of claim 1, wherein the user data comprises site interaction data regarding interaction of the consumer with one or more portions of a web site or a mobile application associated with the vehicle dealer.

6. The computer-implemented method of claim 1, wherein the user data comprises demographic data regarding the consumer, including one or more of the following: a location associated with the user, an income associated with the user, an age of the user, price preferences associated with the consumer, or prior vehicle purchases or leases by the consumer.

7. The computer-implemented method of claim 1, wherein the message content comprises communication content within an e-mail message sent by the consumer to an e-mail address associated with the vehicle dealer.

8. The computer-implemented method of claim 1, wherein the message content comprises communication content within an electronic chat message from the consumer to a recipient associated with the vehicle dealer.

9. The computer-implemented method of claim 1, wherein the message content comprises communication content within an audio message from the consumer to a representative of the vehicle dealer.

10. The computer-implemented method of claim 9, further comprising:
generating, by the one or more processors, a transcript of at least a portion of a voice call between the consumer and the representative of the vehicle dealer, wherein the transcript comprises of the communication content within the audio message.

11. The computer-implemented method of claim 1, further comprising:
determining, by the one or more processors, a cost to the vehicle dealer associated with providing information to the consumer; and
generating, by the one or more processors, the report to further include a comparison of the costs to the dealer and a value associated with the probability of the consumer taking the specified action associated with the vehicle dealer within the predefined time interval.

12. The computer-implemented method of claim 11, wherein:
the specified action comprises purchasing a vehicle from the vehicle dealer, the vehicle having an expected purchase price; and
the value associated with the probability of the consumer taking the specified action associated with the vehicle dealer within the predefined time interval is based upon the expected purchase price and the probability of the consumer taking the specified action associated with the vehicle dealer within the predefined time interval.

13. A computer system for predicting user actions based upon user interaction, comprising:
one or more processors;
a program memory coupled to the one or more processors and storing executable instructions that, when executed by the one or more processors, cause the computer system to:
receive a consumer interaction record containing a message content of a message from a consumer to a vehicle dealer and an indication of the consumer;
parse the message content into a plurality of message features corresponding to input categories of a predictive model;
obtain user data associated with the consumer based upon the indication of the consumer;
extract user data features corresponding to further input categories of the predictive model from the user data;
merge the user data features and the message features to generate an input data set indicating interaction between the consumer and the vehicle dealer;
generate an output value by applying the predictive model to the input data set, the output value indicating a probability of the consumer taking a specified action associated with the vehicle dealer within a predefined time interval; and
present a report including an indication of the probability of the consumer taking the specified action associated with the vehicle dealer within the predefined time interval.

14. The computer system of claim 13, wherein the executable instructions further cause the computer system to:
receive a second consumer interaction record containing a second message content from the consumer to the vehicle dealer and a second indication of the consumer;
parse the second message content into a plurality of second message features corresponding to input categories of the predictive model;
merge the user data features and the second message features to generate a second input data set indicating interaction between the consumer and the vehicle dealer;
generate a second output value by applying the predictive model to the input data set, the second output value indicating a second probability of the consumer taking the specified action associated with the vehicle dealer within the predefined time interval; and
calculate a combined probability of the consumer taking the specified action associated with the vehicle dealer within the predefined time interval based upon the probability and the second probability,
wherein the indication of the probability included in the report is based upon the combined probability of the consumer taking the specified action associated with the vehicle dealer within the predefined time interval.

15. The computer system of claim 13, wherein the message content comprises one or more of the following: communication content within an e-mail message sent by the consumer to an e-mail address associated with the vehicle dealer, communication content within an electronic chat message from the consumer to a recipient associated with the vehicle dealer, or communication content within an audio message from the consumer to a representative of the vehicle dealer.

16. A tangible, non-transitory computer-readable medium storing executable instructions for predicting user actions based upon user interaction that, when executed by one or more processors of a computer system, cause the computer system to:
receive a consumer interaction record containing a message content of a message from a consumer to a vehicle dealer and an indication of the consumer;
parse the message content into a plurality of message features corresponding to input categories of a predictive model;
obtain user data associated with the consumer based upon the indication of the consumer;
extract user data features corresponding to further input categories of the predictive model from the user data;
merge the user data features and the message features to generate an input data set indicating interaction between the consumer and the vehicle dealer;
generate an output value by applying the predictive model to the input data set, the output value indicating a probability of the consumer taking a specified action associated with the vehicle dealer within a predefined time interval; and
present a report including an indication of the probability of the consumer taking the specified action associated with the vehicle dealer within the predefined time interval.

17. The tangible, non-transitory computer-readable medium of claim 16, further storing executable instructions that cause the computer system to:
receive a second consumer interaction record containing a second message content from the consumer to the vehicle dealer and a second indication of the consumer;
parse the second message content into a plurality of second message features corresponding to input categories of the predictive model;
merge the user data features and the second message features to generate a second input data set indicating interaction between the consumer and the vehicle dealer;
generate a second output value by applying the predictive model to the input data set, the second output value indicating a second probability of the consumer taking the specified action associated with the vehicle dealer within the predefined time interval; and
calculate a combined probability of the consumer taking the specified action associated with the vehicle dealer within the predefined time interval based upon the probability and the second probability,
wherein the indication of the probability included in the report is based upon the combined probability of the consumer taking the specified action associated with the vehicle dealer within the predefined time interval.

18. The tangible, non-transitory computer-readable medium of claim 16, wherein the message content comprises one or more of the following: communication content within an e-mail message sent by the consumer to an e-mail address associated with the vehicle dealer, communication content within an electronic chat message from the consumer to a recipient associated with the vehicle dealer, or communication content within an audio message from the consumer to a representative of the vehicle dealer.

19. The tangible, non-transitory computer-readable medium of claim 16, wherein the user data comprises one or both of the following: demographic data regarding the consumer or site interaction data regarding interaction of the consumer with one or more portions of a web site or a mobile application associated with the vehicle dealer.

20. The tangible, non-transitory computer-readable medium of claim 16, wherein the specified action comprises purchasing a vehicle from the vehicle dealer, the vehicle having an expected purchase price, and the tangible, non-transitory computer-readable medium further storing executable instructions that cause the computer system to:
determine a cost to the vehicle dealer associated with providing information to the consumer;
determine a value associated with the probability of the consumer taking the specified action associated with the vehicle dealer within the predefined time interval, the value being based upon the expected purchase price and the probability of the consumer taking the specified action associated with the vehicle dealer within the predefined time interval; and
generate the report to further include a comparison of the costs to the dealer and the value associated with the probability of the consumer taking the specified action associated with the vehicle dealer within the predefined time interval.
